(19) United States
(12) Patent Application Publication
(10) Pub. No.: US 2025/0148944 A1
(43) Pub. Date: May 8, 2025

(54) Projection Method and Projection System for Augmented Reality Applications

(71) Applicant: QISDA CORPORATION, Taoyuan City (TW)

(72) Inventor: Hsu-Sheng Ho, Taoyuan City (TW)

(73) Assignee: QISDA CORPORATION, Taoyuan City (TW)

(21) Appl. No.: 18/936,963

(22) Filed: Nov. 4, 2024

(30) Foreign Application Priority Data
Nov. 7, 2023 (CN) 202311466866.7

(51) Int. Cl. G09G 3/00; G06T 3/08; G06T 3/40; G06T 5/80; G06T 7/73; G06T 19/20

(52) U.S. Cl. CPC G09G 3/003; G06T 3/08; G06T 3/40; G06T 5/80; G06T 7/74; G09G 2320/0693; G09G 2340/0464

(57) ABSTRACT

A projection method includes establishing a projection map of an environmental space according to at least one displacement vector and at least one deflection angle of a projector, identifying at least one feature position point in the environmental space by using a distance sensor, updating the projection map for generating a projection feature map according to the at least one feature position point, and calibrating a projection surface projected by the projector for compensating distortions of the projection surface.

### BACKGROUND OF THE INVENTION

### 1. Field of the Invention

The present invention discloses a projection method and a projection system, and more particularly, a projection method and a projection system for Augmented Reality Applications.

### 2. Description of the Prior Art

With the rapid development of technology, various augmented reality (AR) technologies, drawing applications, and video games are popularly introduced and physically interacted with users. Conventional projectors are hard to move so that they can only project images at a fixed position. Therefore, projected images may exceed a maximum projection range supported by the conventional projector, especially in wide-area display surfaces in museums, extended desktop projection applications, or displaying three-dimensional drawings and models for video game applications. Currently, when the projected images exceed the maximum projection range of a single projector, a plurality of projectors can be introduced for stitching images. Further, special software can be used for realizing transition images.

Since the projectors are miniaturized over time, the projectors can be used for interacting with users. For example, a micro-projector can be used for inputting operation options of users. The micro-projector can be designed in a form of a head-mounted device, a portable device, or a handheld device. However, since the micro-projector can be moved by the user, the micro-projector can be used for projecting the images as virtual AR objects according to environmental features and user's perspective information.

Therefore, developing a micro projector capable of detecting the environmental features and the user's perspective information under various scenes is an important design issue.

### SUMMARY OF THE INVENTION

In an embodiment of the present invention, a projection method is disclosed. The projection method comprises establishing a projection map of an environmental space according to at least one displacement vector and at least one deflection angle of a projector, identifying at least one feature position point in the environmental space by using a distance sensor, updating the projection map for generating a projection feature map according to the at least one feature position point, and calibrating a projection surface projected by the projector for compensating distortions of the projection surface.

In another embodiment of the present invention, a projection system is disclosed. The projection system comprises a projection surface and a projector. The projection surface is configured to display an image. The projector comprises a distance sensor configured to detect at least one focal length between the projector and the projection surface, a memory configured to save data, and a processor coupled to the distance sensor and the memory. The processor establishes a projection map of an environmental space according to at least one displacement vector and at least one deflection angle of the projector. The distance sensor identifies at least one feature position point in the environmental space. The processor updates the projection map for generating a projection feature map according to the at least one feature position point. The processor calibrates the projection surface projected by the projector for compensating distortions of the projection surface, and the projection map and the projection feature map are saved in the memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a projection system according to an embodiment of the present invention.

FIG. 2 is an illustration of corresponding focal lengths when a projector of the projection system in FIG. 1 is moved along a horizontal direction in an environmental space.

FIG. 3 is an illustration of corresponding focal lengths when the projector of the projection system in FIG. 1 is arbitrarily moved in the environmental space.

FIG. 4A is an illustration of focal lengths between corresponding blocks of a projection surface and a distance sensor when the distance sensor of the projector of the projection system in FIG. 1 is moved in the environmental space along a horizontal direction.

FIG. 4B is an illustration of a horizontal tilt angle of the projection surface of the projection system in FIG. 1.

FIG. 4C is an illustration of focal lengths between corresponding blocks of the projection surface and the distance sensor when the distance sensor of the projector of the projection system in FIG. 1 is moved in the environmental space along a vertical direction.

FIG. 4D is an illustration of a vertical tilt angle of the projection surface of the projection system in FIG. 1.

FIG. 5A is an illustration of performing multiple samples on a convex projection surface of the projection system in FIG. 1.

FIG. 5B is an illustration of performing multiple samples on a cornered projection surface of the projection system in FIG. 1.

FIG. 6 is a flow chart of performing a projection method by the projection system in FIG. 1.

### DETAILED DESCRIPTION

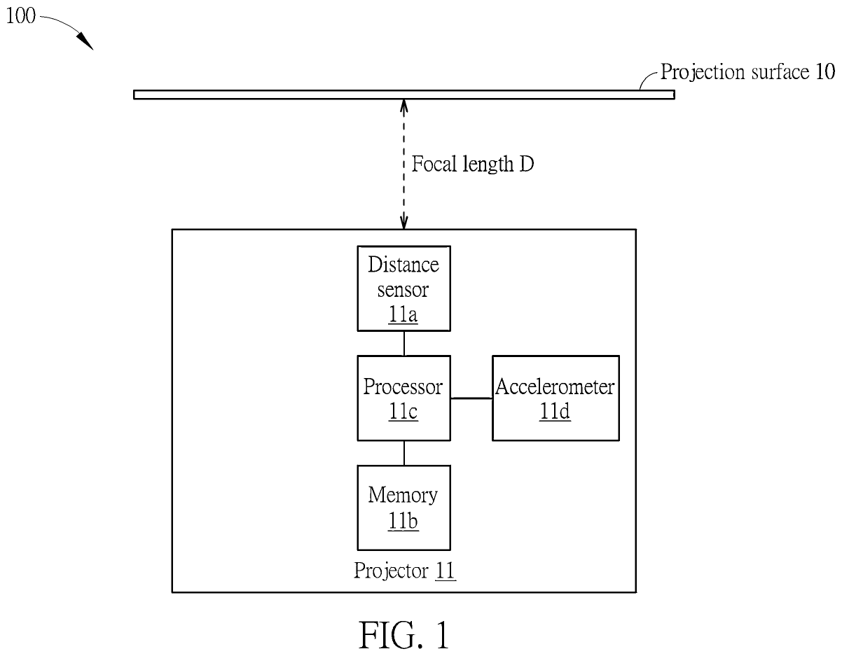

FIG. 1 is a block diagram of a projection system 100 according to an embodiment of the present invention. The projection system 100 includes a projection surface 10 and a projector 11. The projection surface 10 can be any wall or screen for displaying an image. The projector 11 includes a distance sensor 11a, a memory 11b, and a processor 11c. The distance sensor 11a is used for detecting at least one focal length D between the projector 11 and the projection surface 10. The distance sensor 11a can be a time of flight (ToF) sensor. The memory 11b is used for saving data. The processor 11c is coupled to the distance sensor 11a and the memory 11b. The structure of the projector 11 of the projection system 100 in the present invention is not limited by particular hardware. For example, in other embodiments, the projector 11 can also include an accelerometer 11d. The accelerometer 11d is coupled to the processor 11c. The accelerometer 11d can be a gyroscope for sensing three-dimensional deflection angles of the projector 11. In the projection system 100, the processor 11c can establish a projection map of an environmental space according to at least one displacement vector and at least one deflection angle of the projector 11. The distance sensor 11a can identify at least one feature position point in the environmental space. The processor 11c can update the projection map for generating a projection feature map according to at least one feature position point. The processor 11c can calibrate the projection surface 10 projected by the projector 11 for compensating distortions of the projection surface 10. Further, in the projection system 100, the projector 11 can be a wearable projector, such as a head-mounted projector or a handheld projector. The projection map and the projection feature map are saved in the memory 11b. Details of establishing the projection map and the projection feature map by the projection system 100 are illustrated later.

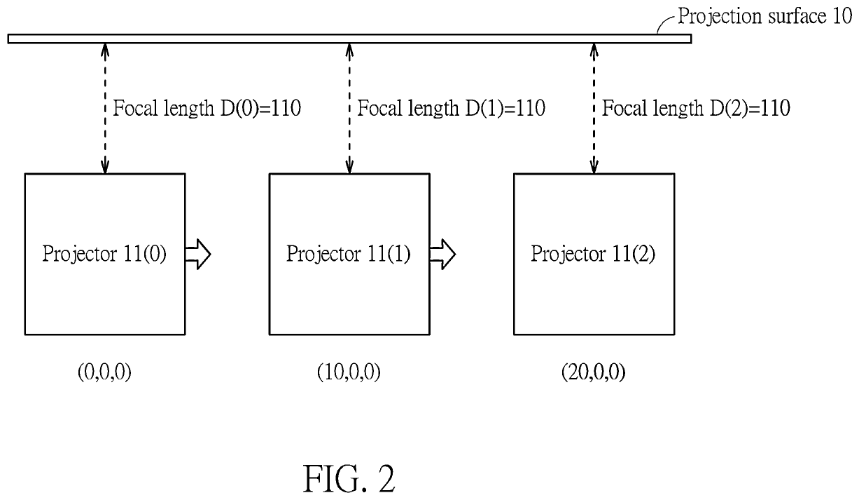

FIG. 2 is an illustration of corresponding focal lengths when the projector 11 of the projection system 100 is moved along a horizontal direction in the environmental space. As previously mentioned, the projector 11 can be the wearable projector. Therefore, the projector 11 can provide high portability and mobility. In FIG. 2, coordinates of a starting point of the projector 11(0) in the environmental space can be set as (0,0,0). Here, (0,0,0) can be regarded as initial coordinates of the projector 11 (hereafter, say, coordinates (0,0,0) of the projector 11(0)). When the projector 11(0) moves along a right direction to a position of the projector 11(1), a coordinate on the x-axis is increased. As a result, coordinates of the projector 11(1) can be expressed as (10,0,0). Similarly, when the projector 11(1) moves along the right direction to a position of the projector 11(2), the coordinate on the x-axis is increased. As a result, coordinates of the projector 11(2) can be expressed as (20,0,0). Further, since the projection surface 10 is a horizontal projection surface, focal lengths from the projectors 11(0), 11(1), and 11(2) at different horizontal positions to the projection surface 10 are identical. In other words, in FIG. 2, a focal length D(0), a focal length D(1), and a focal length D(2) are identical, such as 110 centimeters (cm).

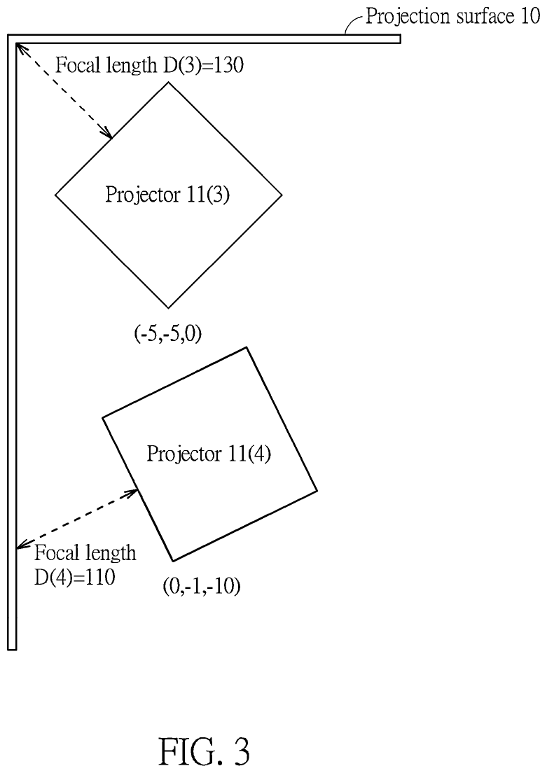

FIG. 3 is an illustration of corresponding focal lengths when the projector 11 of the projection system 100 is arbitrarily moved in the environmental space. The projector 11 can not only move along the horizontal direction or the vertical direction, but also can move arbitrarily within the environmental space. As previously mentioned, the processor 11c can initially set the starting point (0,0,0) of the projector 11 in the environmental space. Then, the projector 11 can arbitrarily move from the starting point (0,0,0) in the environmental space so that the accelerometer 11d can acquire three-dimensional displacement vectors in the environmental space. For example, in FIG. 3, when the projector 11 moves from the starting point (0,0,0) to a position of the projector 11(3), coordinates on the x-axis and the y-axis are decreased. Therefore, coordinates of the projector 11(3) can be expressed as (−5,−5,0). At this time, a focal length D(3) between the projector 11(3) and the projection surface 10 is equal to 130 cm. Similarly, when the projector 11 moves from the starting point (0,0,0) to a position of projector 11(4), coordinates on the x-axis and the y-axis are decreased. Therefore, coordinates of the projector 11(4) can be expressed as (0,−1,10). At this time, a focal length D(4) between the projector 11(4) and the projection surface 10 is equal to 110 cm. Here, the accelerometer 11d can acquire the three-dimensional displacement vectors of the projector 11 in the environmental space. Further, when the projector 11 rotates in the environmental space at the starting point (0,0,0), the accelerometer 11d can acquire three-dimensional deflection angles in the environmental space. In other words, by using the distance sensor 11a and the accelerometer 11d, the three-dimensional displacement vectors, the three-dimensional deflection angles, and the corresponding focal lengths between the projector 11 and the projection surface 10 in the environmental space at different time points can be acquired.

To establish the projection map, in the projection system 100, the accelerometer 11d can detect a set of three-dimensional displacement vectors corresponding to the projector 11 in different moving directions. Further, the accelerometer 11d can detect a set of three-dimensional deflection angles corresponding to the projector 11 at different rotation angles. The processor 11c can use the distance sensor 11a for detecting a plurality of focal lengths between the projection surface 10 and the projector 11 in the different moving directions and the different rotation angles after the set of three-dimensional displacement vectors and the set of three-dimensional deflection angles are acquired. Then, the processor 11c can establish the projection map according to the set of three-dimensional displacement vectors, the set of three-dimensional deflection angles, and the plurality of focal lengths. The projection map can be presented in a form of Table T1. Specifically, the focal length D must comply with a reasonable value of a lens focus range of the projector 11. Table T1 is illustrated below.

TABLE T1

| three-dimensional | three-dimensional | focal |
|---|---|---|
| displacement vectors | deflection angles | length |
| (cm) of the projector 11 | of the projector 11 | D (cm) |
| (0, 0, 0) | (0, 0, 0) | 100 |
| (20, 0, 0) | (0, 0, 0) | 100 |
| (30, 0, 0) | (0, 0, 0) | 100 |
| (−5, −5, 0) | (0, 0, −45) | 130 |
| (−3, −10, 0) | (0, 0, −90) | 80 |

Therefore, by establishing the projection map, a virtual projection range can be determined. The image can be scaled according to the virtual projection range. Further, corresponding coordinates can be acquired according to movement information and rotation information of the projector 11. Finally, a position of the projector 11 in the environmental space can be captured. The image can be projected by the projector 11 accordingly.

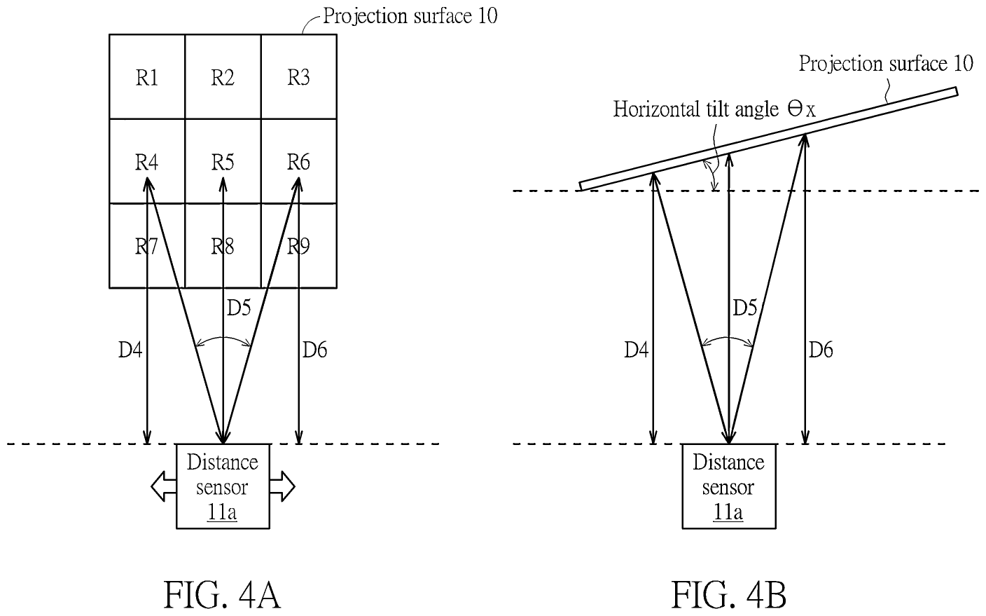

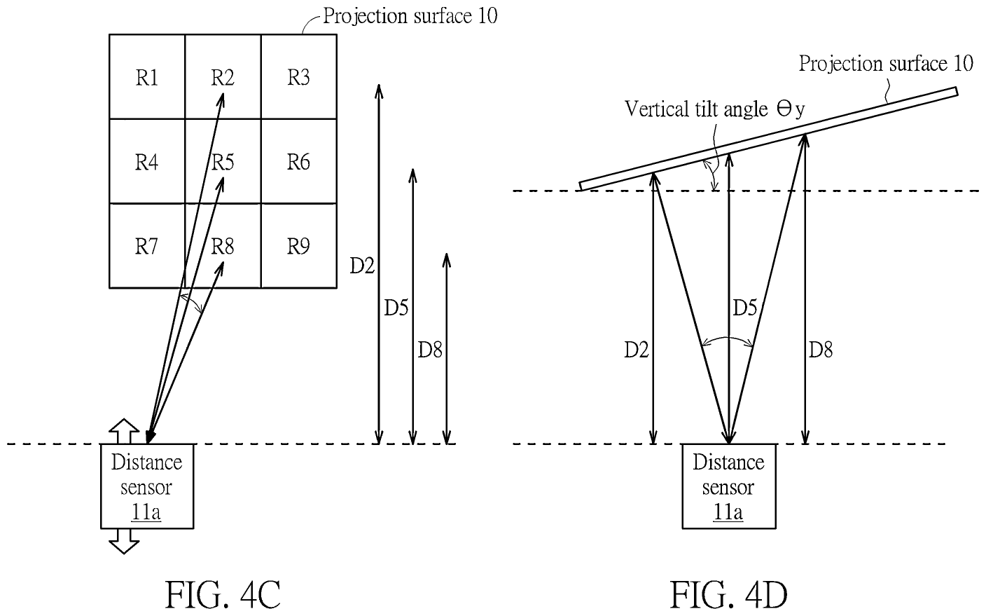

FIG. 4A is an illustration of focal lengths between corresponding blocks of the projection surface 10 and the distance sensor 11a when the distance sensor 11a of the projector 11 of the projection system 100 is moved in the environmental space along a horizontal direction. FIG. 4B is an illustration of a horizontal tilt angle θx of the projection surface 10 of the projection system 100. The projection system 100 is capable of determining at least one physical feature of the projection surface 10, as described below. In FIG. 4A, the projection surface 10 can be partitioned into a plurality of blocks, denoted as R1 to R9. When the distance sensor 11a moves along the horizontal direction in the environmental space, it can continuously acquire a plurality of horizontal tilt angles between the projector 11 and the projection surface 10 in the environmental space. In FIG. 4A, the distance sensor 11a can detect a focal length D4 corresponding to a block R4, a focal length D5 corresponding to a block R5, and a focal length D6 corresponding to a block R6. The block R4, the block R5 and the block R6 are allocated horizontally. Therefore, as shown in FIG. 4B, the distance sensor 11a can derive the horizontal tilt angle θx according to the focal length D4 corresponding to the block R4, the focal length D5 corresponding to the block R5, and the focal length D6 corresponding to a block R6. Here, the horizontal tilt angle θx for the blocks R4 to R6 is called as a horizontal tilt angle θx[456] hereafter. It can be understood that when the projection surface 10 is a flat surface, horizontal tilt angles for different row blocks detected by the distance sensor 11a are substantially identical, denoted as θx[123]≈˜θx[456]≈θx[789].

FIG. 4C is an illustration of focal lengths between corresponding blocks of the projection surface 10 and the distance sensor 11a when the distance sensor 11a of the projector 11 of the projection system 100 is moved in the environmental space along a vertical direction. FIG. 4D is an illustration of a vertical tilt angle θy of the projection surface 10 of the projection system 100. In FIG. 4C, the projection surface 10 can be partitioned into a plurality of blocks, denoted as R1 to R9. When the distance sensor 11a moves along the vertical direction in the environmental space, it can continuously acquire a plurality of vertical tilt angles between the projector 11 and the projection surface 10 in the environmental space. In FIG. 4C, the distance sensor 11a can detect a focal length D2 corresponding to a block R2, a focal length D5 corresponding to a block R5, and a focal length D8 corresponding to a block R8. The block R2, the block R5 and the block R8 are allocated vertically. Therefore, as shown in FIG. 4D, the distance sensor 11a can derive the vertical tilt angle θy according to the focal length D2 corresponding to the block R2, the focal length D5 corresponding to the block R5, and the focal length D8 corresponding to a block R8. Here, the vertical tilt angle θy for the blocks R2, R5, and R8 is called as a vertical tilt angle θy[258] hereafter. It can be understood that when the projection surface 10 is a flat surface, vertical tilt angles for different column blocks detected by the distance sensor 11a are substantially identical, denoted as θy[147]≈θy[258]≈θy[369].

As previously mentioned, the distance sensor 11a can detect the plurality of horizontal tilt angles (i.e., θx[123], θx[456], θx[789]) and the plurality of vertical tilt angles (i.e., θy[147], θy[258], θy[369]). Then, the processor 11c can acquire an average horizontal tilt angle θxavg according to the plurality of horizontal tilt angles. The processor 11c can acquire an average vertical tilt angle θyavg according to the plurality of vertical tilt angles. Further, the processor 11c can derive a horizontal angle variation Δθ_{X} according to the plurality of horizontal tilt angles, as written below.

$$Δ {θ}_{X} = \frac{1}{n} \sqrt{{\sum }_{k = 1}^{n} ( {θ}_{Xk} - {θ}_{Xavg} )}$$

Here, n is a maximum index of available blocks of the projection surface 10. The horizontal angle variation can be regarded as a standard deviation of the horizontal tilt angles on the projection surface 10. When the projection surface 10 is a flat projection surface, the horizontal angle variation Δθ_{X} should be close to zero. Similarly, the processor 11c can derive a vertical angle variation Δθ_{Y} according to the plurality of vertical tilt angles, as written below.

$$Δ {θ}_{Y} = \frac{1}{n} \sqrt{{\sum }_{k = 1}^{n} ( {θ}_{Yk} - {θ}_{Yavg} )}$$

Here, n is the maximum index of the available blocks of the projection surface 10. The vertical angle variation can be regarded as a standard deviation of the vertical tilt angles on the projection surface 10. When the projection surface 10 is the flat projection surface, the vertical angle variation Δθ_{Y} should be close to zero. Then, the processor 11c can identify at least one feature position point of the environmental space. Details are illustrated below.

First, the processor 11c can set a threshold angle δ_{flat}. The threshold angle δ_{flat} can be used for determining if the projection surface 10 is a flat wall. For example, in an embodiment, a sum of the horizontal angle variation Δθ_{X} and the vertical angle variation Δθ_{Y} is greater than the threshold angle δ_{flat}, such as:

$$Δ {θ}_{X} + Δ {θ}_{Y} > {δ}_{flat}$$

It implies that at least one feature position point of the projection surface 10 includes a non-flat surface position point. There may be a corner or an obstruction located on the projection surface 10. In another embodiment, a sum of the horizontal angle variation 40x and the vertical angle variation Δθ_{Y} is smaller or equal to the threshold angle δ_{flat}, such as:

$$Δ {θ}_{X} + Δ {θ}_{Y} \leq {δ}_{flat}$$

It implies that at least one feature position point of the projection surface 10 includes a flat surface position point. By using such detection technology, the processor 11c can update the projection map according to the horizontal angle variation Δθ_{X} and the vertical angle variation Δθ_{Y} corresponding to at least one feature position point for generating the projection feature map. The projection feature map can be present in a form of Table T2, as illustrated below.

TABLE T2

| three-dimensional | three-dimensional | focal | |
|---|---|---|---|
| displacement vectors | deflection angles | length | Δθ_{X} + |
| (cm) of the projector 11 | of the projector 11 | D (cm) | Δθ_{Y} |
| (0, 0, 0) | (0, 0, 0) | 100 | 0 |
| (20, 0, 0) | (0, 0, 0) | 100 | 0 |
| (30, 0, 0) | (0, 0, 0) | 100 | 3 |

As shown in Table T2, when the three-dimensional displacement vectors of the projector 11 are (30,0,0) and the three-dimensional deflection angles of the projector 11 are (0,0,0), the projection surface 10 at a focal length of 100 (cm) is not a flat wall (δ_{flat}<3). For example, a corner or obstruction may be located on the projection surface 10. It can be understood that the image distortion or image deformation may occur when the projection surface 10 is not the flat wall. Details of calibrating the image distortion or image deformation of the image projected on the “non-flat” projection surface 10 are illustrated below.

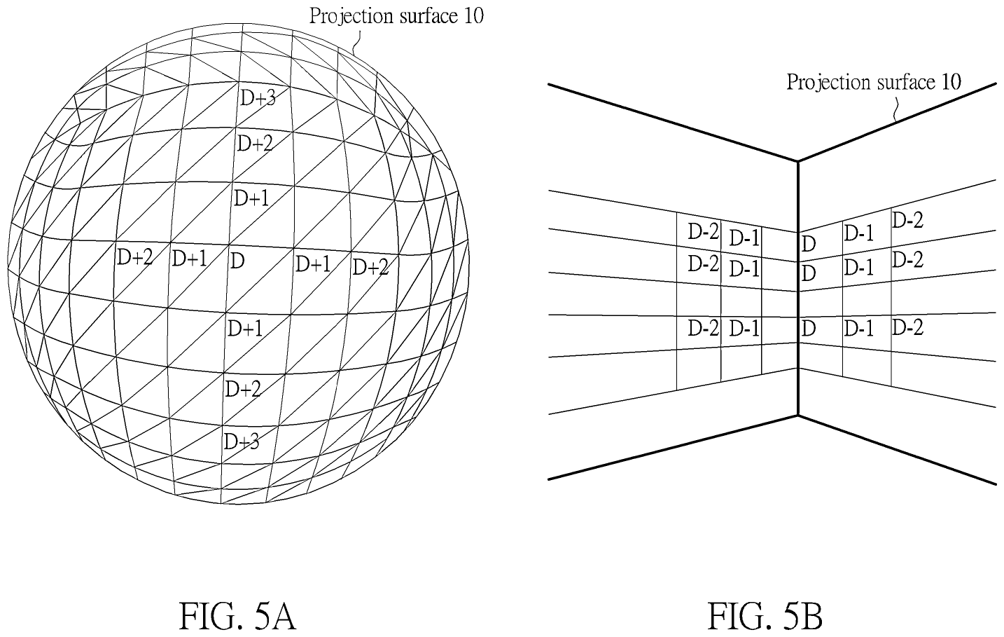

FIG. 5A is an illustration of performing multiple samples on a convex projection surface of the projection system 100. FIG. 5B is an illustration of performing multiple samples on a cornered projection surface of the projection system 100. As previously mentioned, when the sum of the horizontal angle variation Δθ_{X} and the vertical angle variation Δθ_{Y} is greater than the threshold angle δ_{flat}, at least one feature position point of the projection surface 10 includes a non-flat surface position point, as shown in Table T2. Therefore, the processor 11c can acquire at least one feature position point of the projection surface 10 (i.e., a feature position point on a non-flat wall) according to the projection feature map. Then, the distance sensor 11a can detect a plurality of focal lengths between the projector 11 and the projection surface 10 by performing multiple samples on a region of at least one feature position point. For example, in FIG. 5A, if a focal length corresponding to the feature position point for Δθ_{X}+Δθ_{Y}=3 of the projection plane 10 is D, the multiple samples can be used for acquiring the plurality of focal lengths around the feature position point. Here, in FIG. 5A, the plurality of focal lengths between the projector 11 and the projection surface 10 are increased when the samples are farther from the feature position point in the horizontal and vertical directions. As a result, it can be determined that the projection surface 10 in FIG. 5A is the convex projection surface. In FIG. 5B, a plurality of focal lengths between the projector 11 and the projection surface 10 are decreased when the samples are farther from the feature position point in the horizontal direction. However, a plurality of focal lengths between the projector 11 and the projection surface 10 are maintained when the samples are farther from the feature position point in the vertical direction. As a result, it can be determined that the projection surface 10 in FIG. 5B includes a corner. In other words, the processor 11c can determine a physical feature of the projection surface 10 according to at least one feature position point and the plurality of focal lengths. As previously mentioned, the image distortion or image deformation may occur when the projection surface 10 is not a flat wall. Therefore, the processor 11c can calibrate the projection surface for compensating the image distortion or image deformation of the projection surface 10 according to the physical feature. For example, when the physical feature of the projection surface 10 is a corner, the processor 11c can perform a corner keystone correction process according to the plurality of focal lengths. When the physical feature of the projection surface 10 is a convex surface or a portion of the projection surface 10 is covered by the obstruction, the processor 11c can perform a digital warping process according to the plurality of focal lengths.

The projection system 100 can be applied in the augmented reality. Therefore, in a human-computer interaction mode, the images projected by the projection system 100 can be virtually generated according to a realistic object. For example, after the processor 11c acquires a focal length or a relative position between the projector 11 and the projection surface 10, when the focal length or the relative position between the projector 11 and the projection surface 10 is changed (i.e., the user moves forward or backward), the processor 11c can scale an image of the projection surface 10. When three-dimensional images are projected, the processor 11c can control the projector 11 to project at least one adjusted three-dimensional image by introducing three-dimensional projection depth information.

In the projection system 100, the “projection map”, the “projection feature map”, and “at least one feature position point (i.e., corresponding to Δθ_{X}+Δθ_{Y})” can be buffered in the memory 11b. The projector 11 worn by the user can move/rotate in the environmental space. Specifically, when the projector 11 detects that the current environment matches with the information of the “projection map”, the “projection feature map”, and “at least one feature position point” are buffered in the memory 11b, the projector 11 can perform an image processing operation and an image correction operation in real time, thereby providing satisfactory two-dimensional images or three-dimensional images. Further, the projection system 100 can define a topic projection surface for increasing the quality of the projected images according to optical parameters of the environmental space. Details are illustrated below.

In one embodiment, the projector 11c can partition the projection surface 10 into a plurality of regions. Then, the projector 11c can acquire a reflectance value of each region of the plurality of regions by the ToF sensor. Different reflectance values correspond to different material regions. For example, reflectance values can be sorted as: a white wall>a gray wall>a wooden surface>a glass surface. The projector 11c can acquire a zone having a maximum reflectance from the projection surface 10 according to a plurality of reflectance values corresponding to the plurality of regions. Alternatively, the projector 11c can acquire a zone having a maximum “average” reflectance from the projection surface 10 according to the plurality of reflectance values corresponding to the plurality of regions. Finally, the processor 11c can determine the zone having the maximum reflectance or the maximum average reflectance as the topic projection surface. In other words, since the topic projection surface corresponds to a material region with a high reflectance value, the quality of the projected image can be increased.

In another embodiment, the projector 11c can partition the projection surface 10 into a plurality of regions. The projector 11c can acquire line feature point information of each region of the plurality of regions, such as the number of lines or non-planar feature point information. Then, the projector 11c can set a weight corresponding to the line feature point information of each region. When a total weight is increased, it implies that the number of position feature points of the projection surface 10 is increased, thereby providing high positioning accuracy. Then, the processor 11c can acquire a zone having a maximum weight from the projection surface 10 according to a plurality of weights corresponding to the plurality of regions. Finally, the processor 11c can determine the zone having the maximum weight as the topic projection surface. In other words, since the topic projection surface corresponds to more position feature points, the high positioning accuracy can be provided for projecting images. However, the present invention is not limited by aforementioned embodiments. For example, the processor 11c can pre-allocate a plurality of projection regions. Then, the processor 11c can dynamically remove at least one projection region from the plurality of projection regions. The processor 11c can switch different subjects projected on the topic projection surface. The plurality of projection regions can be regarded as a planning range for establishing the projection map. Any reasonable technology or hardware modification falls into the scope of the present invention.

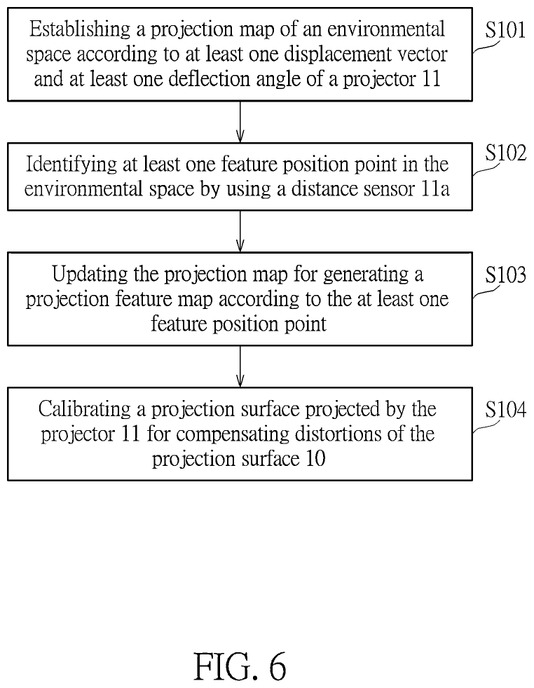

FIG. 6 is a flow chart of performing a projection method by the projection system 100. The projection method includes step S101 to step S104. Any reasonable technology modification of step S101 to step S104 falls into the scope of the present invention. Step S101 to step S104 are illustrated below.
Step S101: establishing a projection map of an environmental space according to at least one displacement vector and at least one deflection angle of a projector 11;
Step S102: identifying at least one feature position point in the environmental space by using a distance sensor 11a;
Step S103: updating the projection map for generating a projection feature map according to the at least one feature position point;
Step S104: calibrating a projection surface projected by the projector 11 for compensating distortions of the projection surface 10.

Details of step S101 to step S104 are previously illustrated. Thus, they are omitted here. In the projection system 100, since the projector 11 is portable, it can be moved by the user. Further, since the projector 11 is movable and rotatable, the projection system 100 can establish the projection map and the projection feature map according to the physical features of the environmental space. Further, the projection system 100 can allocate projection regions and determine the topic projection surface for increasing the quality of the projected images. Therefore, when the projector 11 detects that the current environment matches feature information saved in the memory 11b, the projector 11 can perform the image processing operation and the image correction operation in real time, thereby providing satisfactory two-dimensional images or three-dimensional images.

To sum up, the present invention discloses a projection system and a projection method. The projection system can be applied to a two-dimensional or three-dimensional projection environment space. Further, the projection system can generate the projection map and the projection feature map according to the physical features of the environmental space. The projection system can calibrate the projected images when the projected images are distorted due to the non-flat surface. Further, the projection system can allocate the projection regions and determine the topic projection surface for increasing the quality of the projected images. As a result, when the human-computer interaction mode is performed by the projection system, the projection system can calibrate the projection surface for compensating the image distortion or image deformation in real time according to the physical features of the environmental space, thereby providing satisfactory two-dimensional images or three-dimensional images.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projection method comprising:
establishing a projection map of an environmental space according to at least one displacement vector and at least one deflection angle of a projector;
identifying at least one feature position point in the environmental space by using a distance sensor;
updating the projection map for generating a projection feature map according to the at least one feature position point; and
calibrating a projection surface projected by the projector for compensating distortions of the projection surface.

2. The method of claim 1, wherein establishing the projection map of the environment space according to the at least one displacement vector and the at least one deflection angle of the projector comprises:
setting a starting point;
acquiring three-dimensional displacement vectors in the environmental space by moving the projector in the environmental space from the starting point;
acquiring three-dimensional deflection angles in the environmental space by rotating the projector in the environmental space at the starting point; and
detecting a focal length between the projector and the projection surface by the distance sensor after the three-dimensional deflection angles and the three-dimensional displacement vectors are acquired.

3. The method of claim 2, further comprising:
detecting a set of three-dimensional displacement vectors corresponding to the projector in different moving directions;
detecting a set of three-dimensional deflection angles corresponding to the projector at different rotation angles;
detecting a plurality of focal lengths between the projection surface and the projector in the different moving directions and the different rotation angles after the set of three-dimensional displacement vectors and the set of three-dimensional deflection angles are acquired; and
establishing the projection map according to the set of three-dimensional displacement vectors, the set of three-dimensional deflection angles, and the plurality of focal lengths.

4. The method of claim 1, wherein identifying the at least one feature position point in the environmental space by using the distance sensor comprises:
moving the distance sensor along a horizontal direction in the environmental space for continuously acquiring a plurality of horizontal tilt angles between the projector and the projection surface in the environmental space;
moving the distance sensor along a vertical direction in the environmental space for continuously acquiring a plurality of vertical tilt angles between the projector and the projection surface in the environmental space;
acquiring a horizontal angle variation of the plurality of horizontal tilt angles;
acquiring a vertical angle variation of the plurality of vertical tilt angles; and
identifying the at least one feature position point in the environmental space according to the horizontal angle variation and the vertical angle variation.

5. The method of claim 4, wherein when a sum of the horizontal angle variation and the vertical angle variation is greater than a threshold angle, the at least one feature position point includes a non-flat surface position point of the projection surface, and when the sum of the horizontal angle variation and the vertical angle variation is smaller or equal to the threshold angle, the at least one feature position point includes a flat surface position point of the projection surface.

6. The method of claim 5, wherein updating the projection map for generating the projection feature map according to the at least one feature position point comprises:
updating the projection map according to the horizontal angle variation and the vertical angle variation corresponding to the at least one feature position point for generating the projection feature map.

7. The method of claim 1, wherein calibrating the projection surface projected by the projector for compensating the distortions of the projection surface comprises:
acquiring the at least one feature position point according to the projection feature map;
detecting a plurality of focal lengths between the projector and the projection surface by performing multiple samples on a region of the at least one feature position point by the distance sensor;
determining a physical feature of the projection surface according to the at least one feature position point and the plurality of focal lengths; and
calibrating the projection surface for compensating the distortions of the projection surface according to the physical feature.

8. The method of claim 1, further comprising:
acquiring a focal length or a relative position between the projector and the projection surface; and
scaling an image of the projection surface or projecting a corresponding three-dimensional image by introducing three-dimensional projection depth information when the focal length or the relative position between the projector and the projection surface is changed.

9. The method of claim 1, further comprising:
partitioning the projection surface into a plurality of regions;
acquiring a reflectance value of each region of the plurality of regions;
acquiring a zone having a maximum reflectance from the projection surface according to a plurality of reflectance values corresponding to the plurality of regions; and
determining the zone having the maximum reflectance as a topic projection surface.

10. The method of claim 1, further comprising:
partitioning the projection surface into a plurality of regions;
acquiring line feature point information of each region of the plurality of regions;
setting a weight corresponding to the line feature point information of the each region;
acquiring a zone having a maximum weight from the projection surface according to a plurality of weights corresponding to the plurality of regions; and
determining the zone having the maximum weight as a topic projection surface.

11. A projection system comprising:
a projection surface configured to display an image; and
a projector comprising:
a distance sensor configured to detect at least one focal length between the projector and the projection surface;
a memory configured to save data; and
a processor coupled to the distance sensor and the memory;
wherein the processor establishes a projection map of an environmental space according to at least one displacement vector and at least one deflection angle of the projector, the distance sensor identifies at least one feature position point in the environmental space, the processor updates the projection map for generating a projection feature map according to the at least one feature position point, the processor calibrates the projection surface projected by the projector for compensating distortions of the projection surface, and the projection map and the projection feature map are saved in the memory.

12. The system of claim 11, further comprising:
an accelerometer coupled to the processor;
wherein the processor sets a starting point, the projector moves in the environmental space from the starting point so that the accelerometer acquires three-dimensional displacement vectors in the environmental space, the projector rotates in the environmental space at the starting point so that the accelerometer acquires three-dimensional deflection angles in the environmental space, the distance sensor detects a focal length between the projector and the projection surface after the three-dimensional deflection angles and the three-dimensional displacement vectors are acquired.

13. The system of claim 12, further comprising:
an accelerometer coupled to the processor;
wherein the accelerometer detects a set of three-dimensional displacement vectors corresponding to the projector in different moving directions, the accelerometer detects a set of three-dimensional deflection angles corresponding to the projector at different rotation angles, the distance sensor detects a plurality of focal lengths between the projection surface and the projector in the different moving directions and the different rotation angles after the set of three-dimensional displacement vectors and the set of three-dimensional deflection angles are acquired, and the processor establishes the projection map according to the set of three-dimensional displacement vectors, the set of three-dimensional deflection angles, and the plurality of focal lengths.

14. The system of claim 11, wherein the distance sensor is moved along a horizontal direction in the environmental space for continuously acquiring a plurality of horizontal tilt angles between the projector and the projection surface in the environmental space, the distance sensor is moved along a vertical direction in the environmental space for continuously acquiring a plurality of vertical tilt angles between the projector and the projection surface in the environmental space, the processor acquires a horizontal angle variation of the plurality of horizontal tilt angles, the processor acquires a vertical angle variation of the plurality of vertical tilt angles, and the processor identifies the at least one feature position point in the environmental space according to the horizontal angle variation and the vertical angle variation.

15. The system of claim 14, wherein when a sum of the horizontal angle variation and the vertical angle variation is greater than a threshold angle, the at least one feature position point includes a non-flat surface position point of the projection surface, and when the sum of the horizontal angle variation and the vertical angle variation is smaller or equal to the threshold angle, the at least one feature position point includes a flat surface position point of the projection surface.

16. The system of claim 15, wherein the processor updates the projection map according to the horizontal angle variation and the vertical angle variation corresponding to the at least one feature position point for generating the projection feature map.

17. The system of claim 11, wherein the processor acquires the at least one feature position point according to the projection feature map, the distance sensor detects a plurality of focal lengths between the projector and the projection surface by performing multiple samples on a region of the at least one feature position point, the processor determines a physical feature of the projection surface according to the at least one feature position point and the plurality of focal lengths, and the processor calibrates the projection surface for compensating the distortions of the projection surface according to the physical feature.

18. The system of claim 11, wherein after the processor acquires a focal length or a relative position between the projector and the projection surface, when the focal length or the relative position between the projector and the projection surface is changed, the processor scales an image of the projection surface or controls the projector to project a corresponding three-dimensional image by introducing three-dimensional projection depth information.

19. The system of claim 11, wherein the projector partitions the projection surface into a plurality of regions, the projector acquires a reflectance value of each region of the plurality of regions, the projector acquires a zone having a maximum reflectance from the projection surface according to a plurality of reflectance values corresponding to the plurality of regions, and the processor determines the zone having the maximum reflectance as a topic projection surface.

20. The system of claim 11, wherein the projector partitions the projection surface into a plurality of regions, the projector acquires line feature point information of each region of the plurality of regions, the projector sets a weight corresponding to the line feature point information of the each region, the processor acquires a zone having a maximum weight from the projection surface according to a plurality of weights corresponding to the plurality of regions, and the processor determines the zone having the maximum weight as a topic projection surface.
